(19) United States
(12) Patent Application Publication
(10) Pub. No.: US 2024/0110893 A1
(43) Pub. Date: Apr. 4, 2024

(54) ARTIFICIAL INTELLIGENCE RESONATOR RAPID PATHOGEN DETECTION METHOD

(71) Applicant: TLC Millimeter Wave Products Inc., Minneapolis, MN (US)

(72) Inventors: Timothy Childs, Minnetonka, MN (US); John Geddes, Minneapolis, MN (US); Daniel C. Eller, Silver Lake, MN (US); Jerry W. Cole, Ramsey, MN (US); Kalyani Mantha, Maple Grove, MN (US); Manish Saka, Maple Grove, MN (US)

(21) Appl. No.: 18/481,058

(22) Filed: Oct. 4, 2023

Related U.S. Application Data
(60) Provisional application No. 63/412,988, filed on Oct. 4, 2022.

(51) Int. Cl. G01N 29/036; G01N 29/34

(52) U.S. Cl. CPC G01N 29/036; G01N 29/34; G01N 2291/014; G01N 2291/022

(57) ABSTRACT

A pathogen detection method. A sample that potentially contains a pathogen is collected. A triangle wave form output is produced. A signal associated with the triangle wave form is transmitted from a voltage-controlled oscillator over a plurality of frequencies. The signal is transmitted through the sample to cause the pathogen in the sample to vibrate at a frequency. The vibrations from the sample are detected. A resonance profile of a pathogen in the sample is calculated based upon the vibrations. A database that includes a resonance profile signature of at least one pathogens is provided. The calculated resonance profile is compared to the resonance profile signature database to determine if the sample includes the pathogen.

### REFERENCE TO RELATED APPLICATION

This application claims priority to Provisional Applic. No. 63/412,988, filed on Oct. 4, 2023, the contents of which are incorporated herein by reference.

### FIELD OF THE INVENTION

The invention relates generally to pathogen detection. More particularly, the invention relates to an artificial intelligence resonator rapid pathogen detection method.

### BACKGROUND OF THE INVENTION

Potentially hazardous pathogens may be present in a variety of locations. It is important to identify the pathogens as quickly as possible to take precautions to stop the spread of the pathogens. Additionally, it is important to accurately identify the pathogens because false negative results and false positive results can both have significant implications. Heretofore, there are no methods to quickly and accurately identifying pathogens.

### SUMMARY OF THE INVENTION

An embodiment of the invention is directed to an artificial intelligence resonator rapid pathogen detection system. By training the pathogen detection system on the various unique microwave/millimeter resonant absorption profiles of targeted pathogens such as using machine learning, the pathogen detection system can immediately identify the pathogen from the display of resonance absorption profiles from a biological sample using artificial intelligence.

To calculate the resonance profile of a target virus or pathogen, a multivariate regression analysis equation can be used. The frequencies, v, of the modes can be calculated from the following eigenvalue equation:

4(J₂(ζ)/(J₁(ζ)ζ−η²+2(J₂(η)/J₁(η))η=0
Where: ζ=2πvR/V_{L}
   η=2πvR/V_{T}
   J₁ and J₂ are spherical Bessel functions of the first and second kinds, respectively
   R is the radius of the virus
   V_{L} and V_{T} are the sound velocities of the longitudinal and transverse waves respectively
   V_{L} may be around 1,700 meters per second
   Ratio between V_{L} and V_{T} may be around 2

Using the eigenvalue equation shown above, this invention includes developing a program that provides the resonance frequency of a virus and fits the program to known resonance frequencies. For example, a 30-nanometer spherical particle should have a resonant frequency of 30 to 40 GHz and an influenza A virus with a diameter of about 100 nanometers had a resonant absorption peak around 12 GHz.

A SARS-CoV2 virus can have a diameter of approximately 100 to 120 nanometers. Using the eigenvalue equation, the theoretical resonance absorption peak may be approximately 10 to 12 GHz depending on the specific size of the virus. In addition to the lowest resonance frequency absorption peak corresponding to the lowest eigenvalue there are also largest eigenvalues that may correspond to higher “harmonic” resonance frequency absorption peaks. Such results may be used in the system script program to help guide and compare to the results of the resonator capture program calculated to that created by a resonator.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a configuration diagram of an artificial intelligence resonator pathogen detection system according to an embodiment of the invention.

FIG. 2 is an image of the artificial intelligence resonator rapid pathogen detection system.

FIG. 3 is an image of a sample tube for use in conjunction with the artificial intelligence resonator rapid pathogen detection system.

FIG. 4 is an upper perspective view of a resonator fixture for use in the artificial intelligence resonator rapid pathogen detection system.

FIG. 5 is a partially exploded lower perspective view of the resonator fixture.

FIG. 6 includes unique consistently repeatable signature profiles of SARs-CoV2, versus the unique profiles of Influenza A, CV229 at the listed concentration levels.

FIG. 7 includes signature profiles pf SARs-CoV2 versus concentrations.

FIG. 8 includes the overlap of linear versus frequency to shows the profile trend of SARs-CoV2.

FIG. 9 is a circuit diagram for converting FPGA output to VCO drive.

FIG. 10 is a circuit diagram to convert detector output to FPGA input.

FIG. 11 is a test fixture for resonant detection.

FIG. 12 illustrates a top level block diagram for FPGA implementation.

FIG. 13 illustrates DAC RTL implementation.

FIG. 14 illustrates a simulation output from the DAC RTL implementation.

FIG. 15 illustrates the oscilloscope output from the DAC RTL implementation.

FIG. 16 is a NIOS II Development environment.

FIG. 17 is a schematic diagram of the components in the NIOS development environment.

FIG. 18 illustrates the process flow and software development cycle.

FIG. 19 is a block diagram of the noro virus detection system.

FIG. 20 is a block diagram of an alternative configuration of the pathogen detection system.

FIG. 21 is a detector for use in conjunction with the pathogen detection system.

FIG. 22 is a graph of 2 sample test results using the pathogen detection system of FIG. 20.

FIG. 23 is a graph of sample test results using the pathogen detection system of FIG. 20.

### DETAILED DESCRIPTION OF THE INVENTION

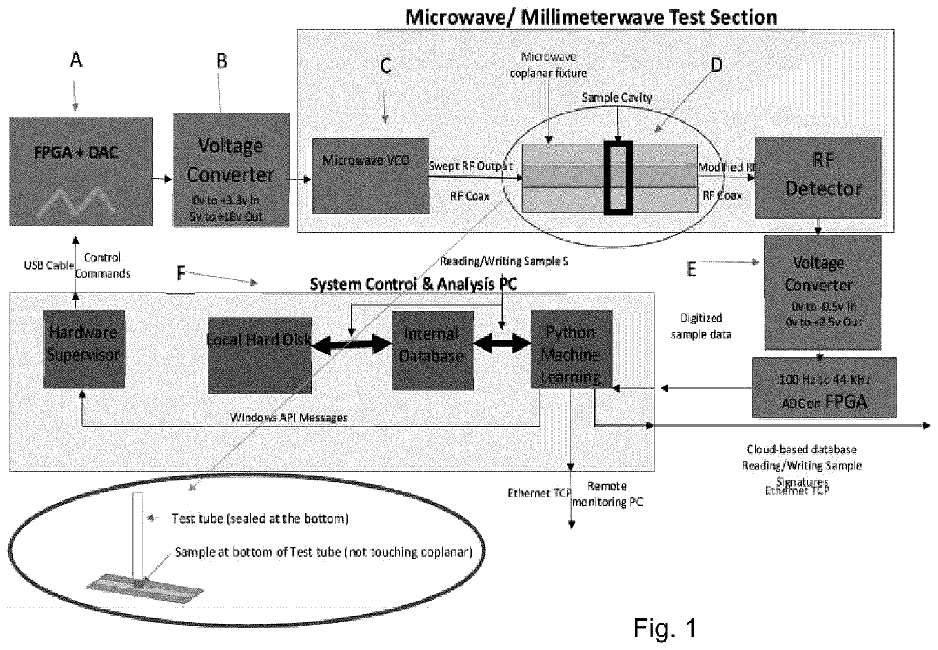

An embodiment of the invention is directed to an artificial intelligence resonator rapid pathogen detection system such as illustrated in FIG. 1. As used herein, rapid pathogen detection means a time between evaluation of the sample and providing results is less than 5 minutes. In other embodiments, the time between evaluation of the sample and providing results is less than 1 minute. In still other embodiments, the time between evaluation of the sample and providing results is less than 30 seconds.

The system electronic signal process and management section contains a field programmable gate array (“FPGA”) that produces a triangle wave output from 0 volts to about +18 volts at a 200 Hz cycle for the test section of the system. With a BNC cable this ramped input voltage ramps the microwave voltage-controlled oscillator (“VCO”) to produce an output frequency from about 2 GHz to about 100 GHz.

The output of the VCO is connected to a coplanar board. This board contains a 50-ohm microstrip center line that transfer RF signal through the sample cavity to excite the liquid biological samples (saliva, blood, mucus, etc.). As the FPGA modulates the VCO, the frequency is swept over a large frequency range (bandwidth). This signal is transmitted into one end of the 50-ohm microstrip line of the coplanar board.

When the transmitted signal reaches directly under the liquid sample that is separated by a membrane positioned on a bottom of the test tube, the radio frequency/millimeter wave signal vibrates molecules of the biological sample. In certain embodiments, the membrane has a thickness of about 0.01 millimeters.

As the frequency increases, the responding pathogens unique molecular resonance frequency profile is captured by the detector vs the frequency. That is, the resonating sample modified RF signal's profiles is captured into an RF detector. The role of the detector is to generate DC voltage patterns as a function of the samples modified RF profiles.

The resolution of the detector may be optimized, and virus signal screened and then amplified to distinguish the pathogen signature from other similar viruses in shape and size to provide rapid and reliable pathogen identification.

In some embodiments, this process may allow over 10,000 variations (angles, power, density, etc.) the unique signature of the pathogen and its mutations to be captured by the detector and in some embodiments stored in a network database. Using millions to billions of scans for artificial intelligence training such as using machine learning, the system can recognize the virus, as well as various variations or mutations of the virus.

Continual testing and training refine/optimize the resolution, especially in the target frequency range of interest. This process helps assure that the nano sensitive detect and identification system matches the machine learned profiles with great accuracy (e.g. >99%) of the pathogen.

In some situations, these systems may be portable such they can be quickly or immediately transferred to perform pathogen identification on surfaces, in rooms, offices, cruise ships, schools as well as in the air or to initiate a cough test. In some embodiments, the detector may also be used for rapid virus identification for agriculture, meats (poultry, beef, pork, etc.), medical and genome/DNA industries.

Item A in FIG. 1 is an FPGA and digital to analog converter (“DAC”) that produces a triangle wave output from 0 volts to about +3.3 volts at a frequency of about 1 KHz.

Item B in FIG. 1 is an operational amplifier (OpAmp voltage converter) to adjust the output of item A to a voltage range output of between about 0 volts to about +18 volts for the microwave voltage-controlled oscillator (“VCO”) (Item C in FIG. 1).

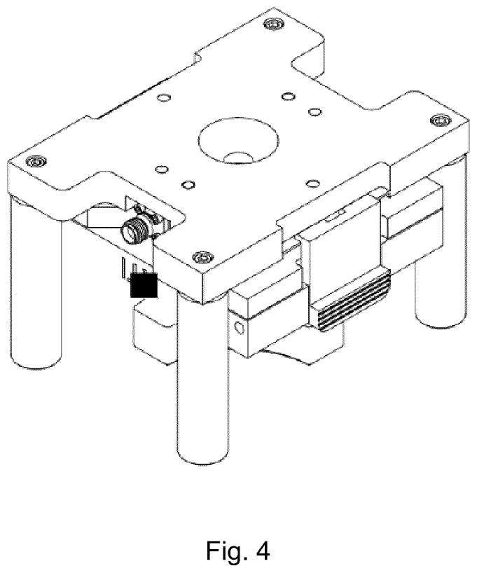

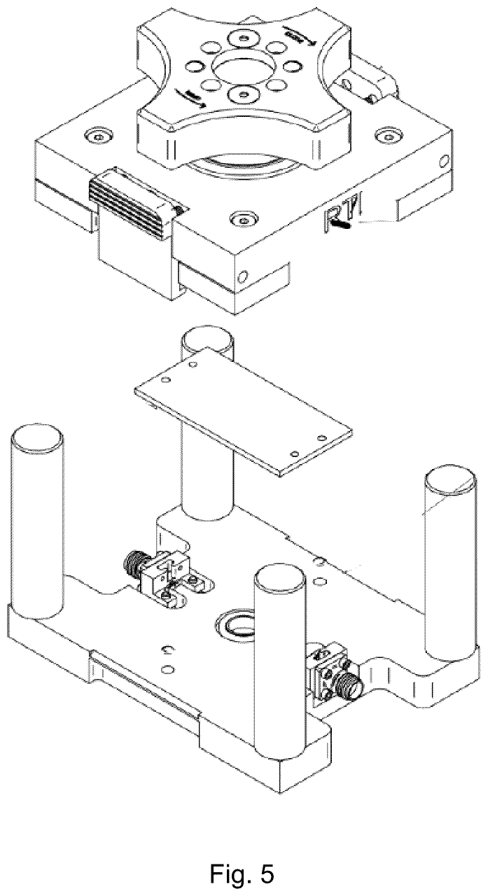

The radio frequency (“RF”) output of the VCO is connected to a coplanar board (Item D in FIG. 1). This resonator board is placed within a fixture (such as illustrated in FIGS. 4 and 5). The fixture holds the test-tube with the liquid biological samples centered on the microstrip lines of the board.

As the FPGA modulates and sweeps the VCO frequency, the signal is directed across the coplanar board over a 50-ohm microstrip line directly under the liquid biological sample. When the unique resonation frequency of the sample's molecules has been obtained, a reduction of the RF drive level will occur.

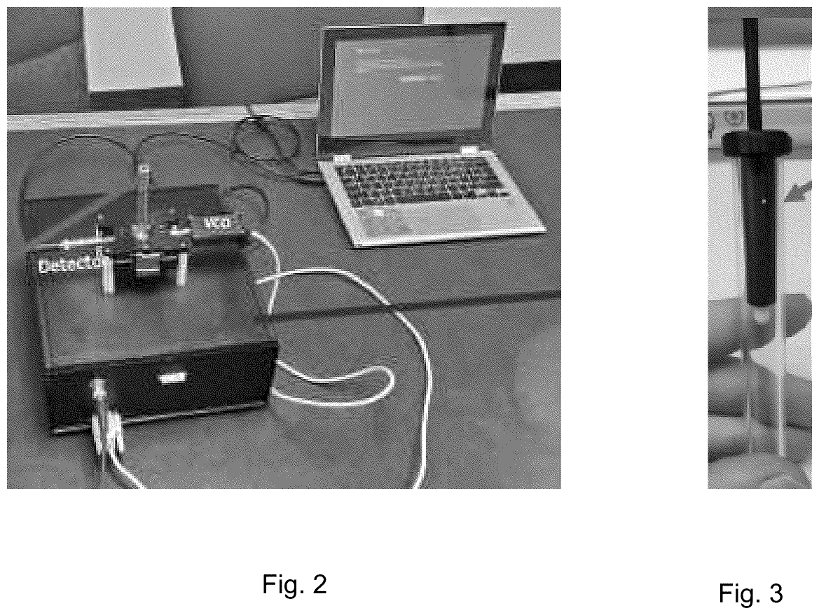

FIG. 2 illustrates an embodiment of the artificial intelligence resonator pathogen detection system that includes 3 main sections—the test station, the electronic box and the analysis computer. The test station includes the VCO, a resonator test fixture and a detector (with swab fluid extractor). The electronic box includes signal control and processing electronic sections. The analysis computer controls the detection system and conducts the machine learning and artificial intelligence analysis.

FIG. 3 illustrates a sample tube for use with the artificial intelligence resonator rapid pathogen detection system. The sample tube may include a swab fluid extractor that is at least partially inserted inside of the sample tube.

FIGS. 4 and 5 are perspective views of a configuration of the fixture that is used in conjunction with the rapid pathogen detection system. In FIG. 5, a lower portion of the fixture is removed to more clearly visualize the configuration of the fixture.

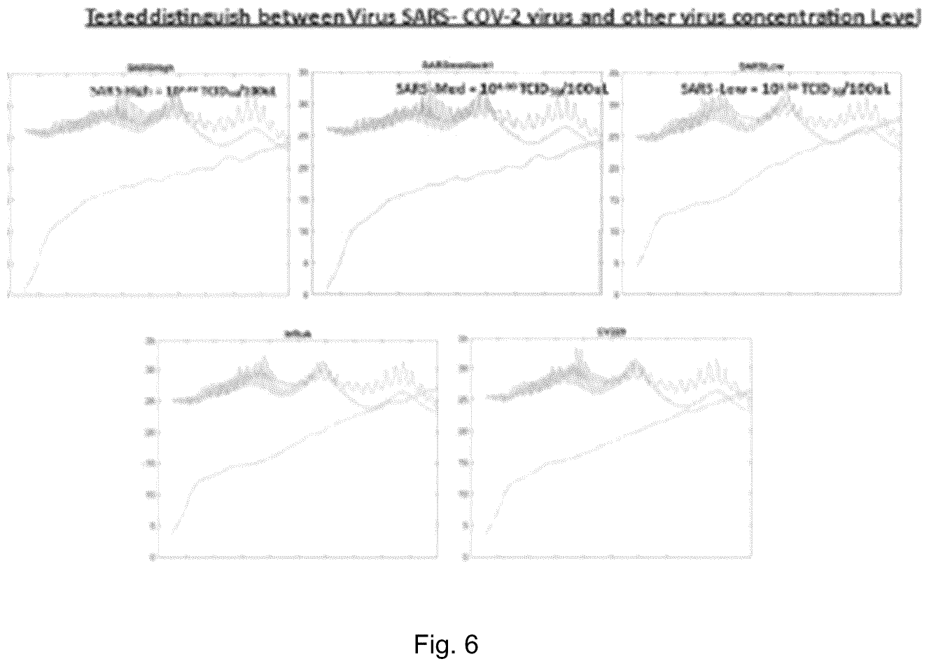

FIG. 6 includes unique consistently repeatable signature profiles of SARs-CoV2, versus the unique profiles of Influenza A, CV229 at the list concentration levels. The difference in the virus profiles versus type and concentration create by the resonator, is visible. Using machine learning, the signatures are learned at a level of detail that is not possible with human visualization and creates the artificial intelligence algorithm to rapidly identify/recognize the unique virus pattern in a biological sample.

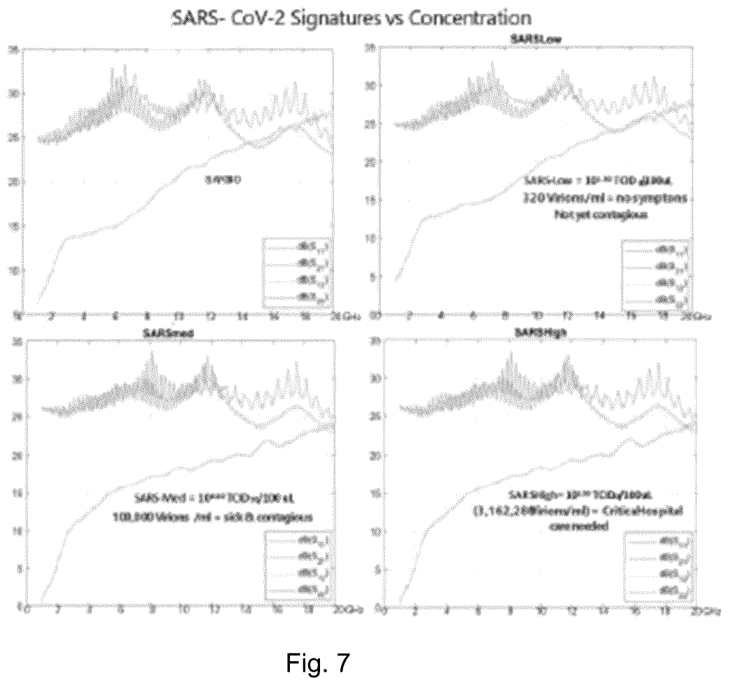

FIG. 7 includes signature profiles of SARs-CoV2 versus concentrations. Each S-parameter creates unique “fingerprint” versus frequency for each sample. Combining all 4 S-parameters lines “fingerprints” represents the unique “signature” of the virus versus concentration and distinguish it from other viruses. The profiles are then modeled, extrapolated and captured using artificial intelligence enable the detection system to rapidly recognize viruses even at very low concentrations such as on the order of 300 virion per milliliter.

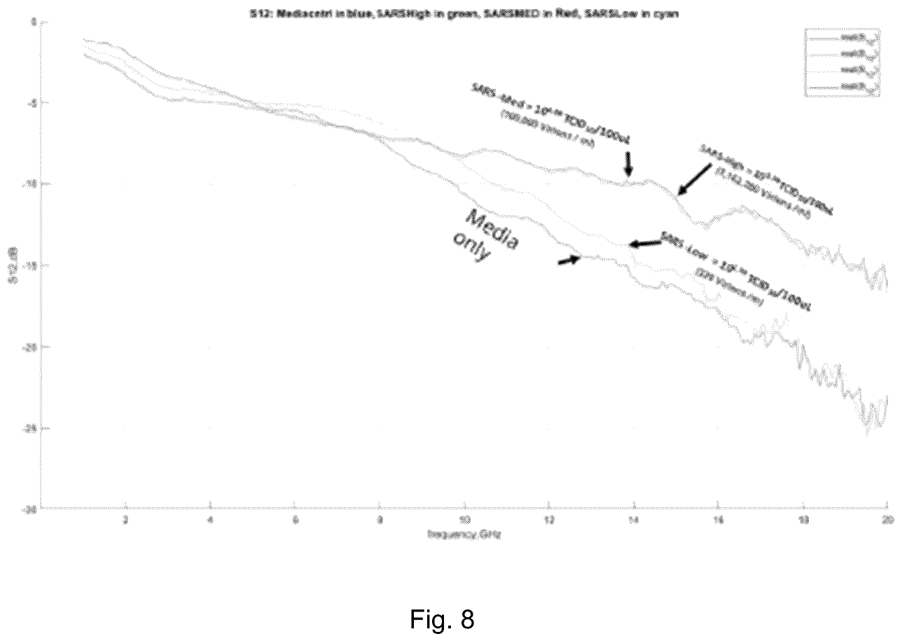

FIG. 8 includes the overlap of linear (reverse amplitude profile) versus frequency to shows the profile trend of SARs-CoV2 the trend from low to high concentrations and limits of detection.

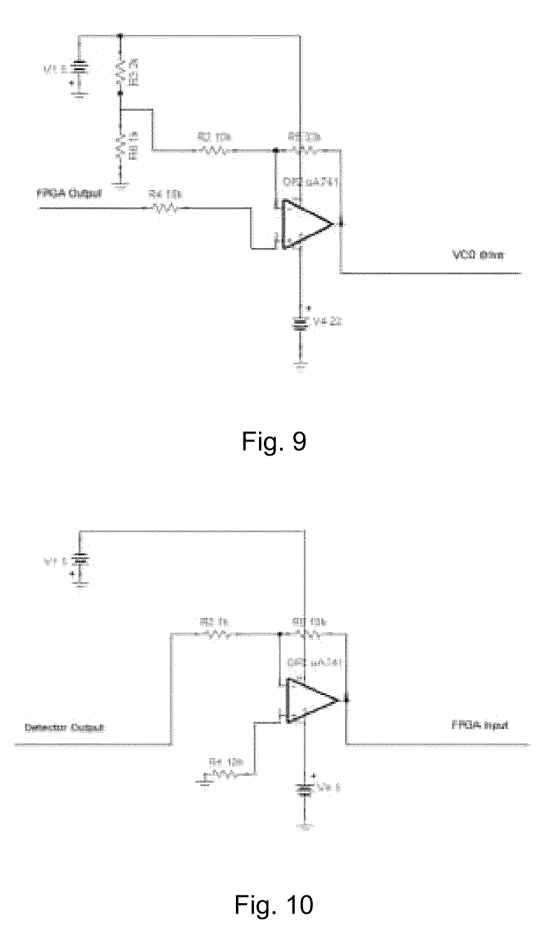

FIG. 9 is a circuit diagram for converting FPGA output to VCO drive. The FPGA will provide a sawtooth or triangle wave output to drive the VCO. However, the FPGA can only produce an output of between about 0 volts and about 3.3 volts, which is not sufficiently large to modulate the VCO.

The circuit in FIG. 9 shifts the average or DC level of the FPGA output and amplifies it so that the VCO drive is a signal with a peak-to-peak amplitude of approximately 11 volts and a DC level of approximately 12 volts. This increased level is sufficient to modulate the current VCO. The DC level can be adjusted by the ratio of R3 to R6. The amplitude is controlled by the ratio of R5 to R2.

FIG. 10 is a circuit diagram to convert detector output to FPGA input. The output of the crystal detector is a negative going voltage with an amplitude of about 0 to −250 millivolts. The FPGA input is designed to work with signal levels of 0 to 2.5 volts. The circuit in FIG. 10 is an inverting amplifier that converts the detector output signal to levels compatible with the FPGA input. The amplifier gain is controlled by the ratio of R5 to R2.

This modified RF signal is directed into a standard RF detector. The role of the detector is to generate a DC voltage as a function of the input RF drive level. This DC volage range of 0 volts to −1 volt is applied to a second 741 OpAmp (voltage converter) to adjust the voltage from 0 volts to +2.5 volts. This signal is directed to the input of the analog to digital converter (“ADC”) of the FPGA (Item E in FIG. 1).

The information collected from the FPGA is sent to a controlling computer over a standard Ethernet cable for target identification and notification (Item F in FIG. 1).

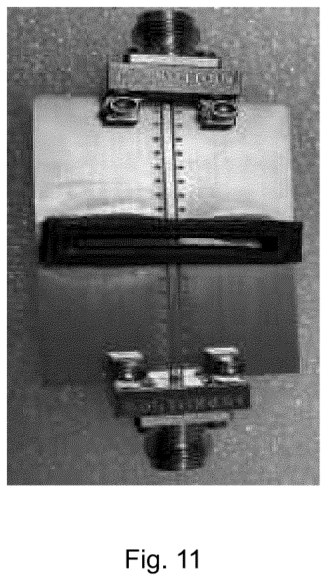

FIG. 11 is a test fixture for resonant detection. This image shows a coplanar design for this application intended for operation up to 20 GHz to detect the Coronavirus. It is possible to modify this design for operation up to about 50 GHz for the Norovirus and higher frequencies for smaller diameter pathogens.

In use, the specimen for test is placed in the dark rectangle with a cavity shown in the center of fixture illustrated in FIG. 4. The microwave signal is introduced to a connector on one end of the test fixture. The output signal at the other end of the fixture is measured to determine if a virus is present in the sample.

This section describes the design and register transfer level (“RTL”) implementation of FPGA modules in the microwave resonation detection system. The FPGA modules contains 2 sections: (1) DAC implementation and (2) NIOS II embedded development environment on Altera Intel Max10 FPGA development kit.

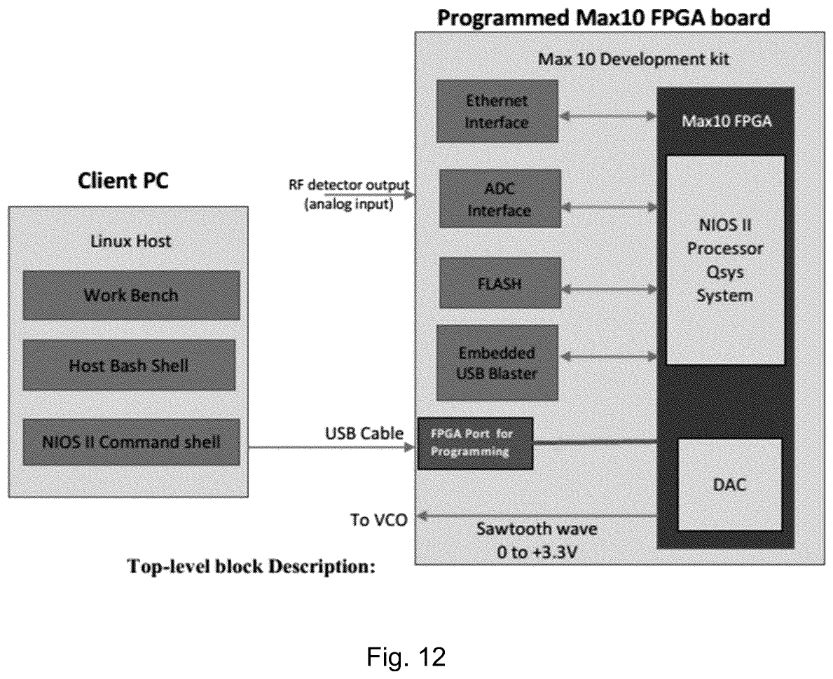

FIG. 12 illustrates a top level block diagram for FPGA implementation of sawtooth generation and NIOS II hardware implementation to boot and run Linux and allow FPGA—client PC communication and flash programming over a cable such as a USB cable.

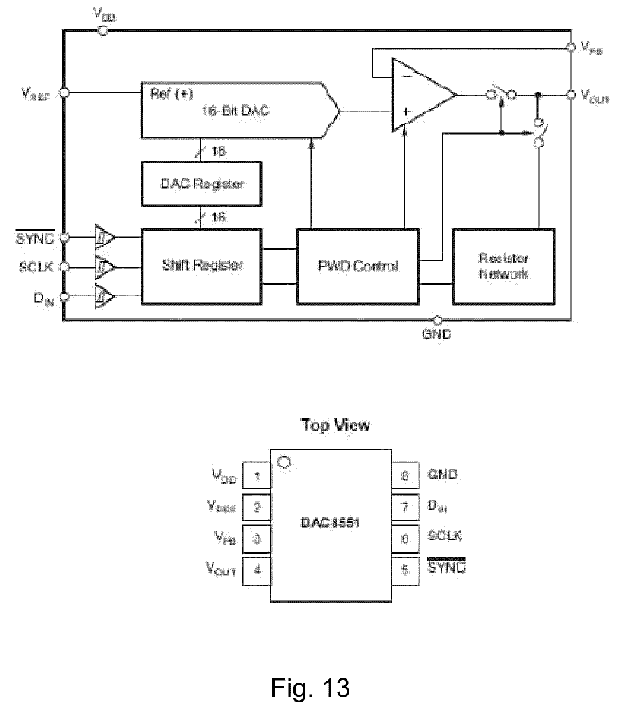

FIG. 13 illustrates DAC RTL implementation. The DAC RTL implementation includes generation of sawtooth waveform output from 0 volts to +3.3 volts at a frequency of about 1 KHz. The DAC output is transferred to the VCO.

The DAC8551 is a small, low-power, voltage output, single-channel, 16-bit, DAC. The DAC8551 uses a versatile, three-wire serial interface that operates at clock rates of up to about 30 MHz and is compatible with standard SPI, QSPI, Micro wire, and digital signal processor (DSP) interfaces.

D_{IN} is serial data input. In certain embodiments, data is clocked into the 24-bit input shift register on each falling edge of the serial clock input. SCLK is a serial clock input. When SYNC goes LOW, it enables the input shift register and data is transferred in on the falling edges of the following clocks. The DAC is updated following the 24th clock (unless SYNC is taken HIGH before this edge, in which case the rising edge of SYNC acts as an interrupt and the write sequence is ignored by the DAC8551).

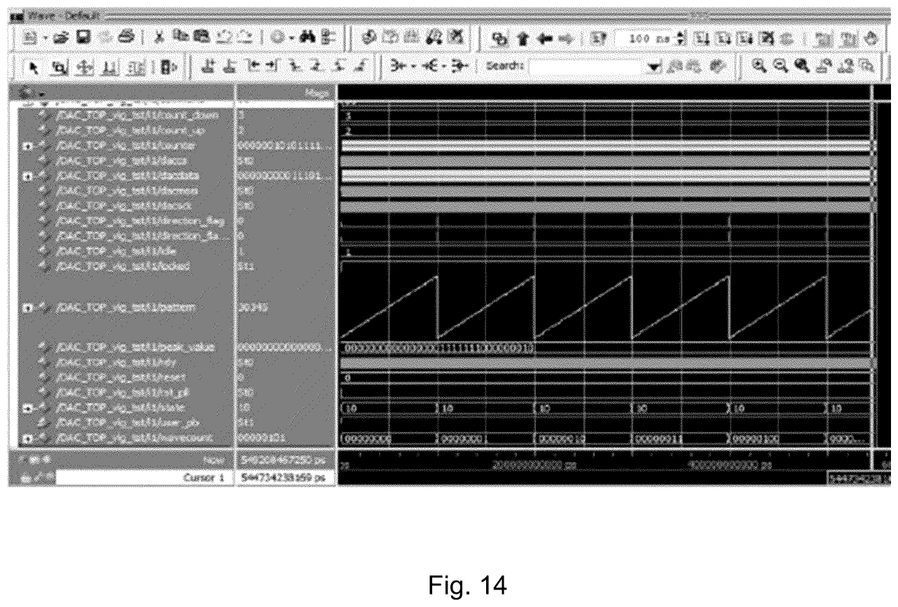

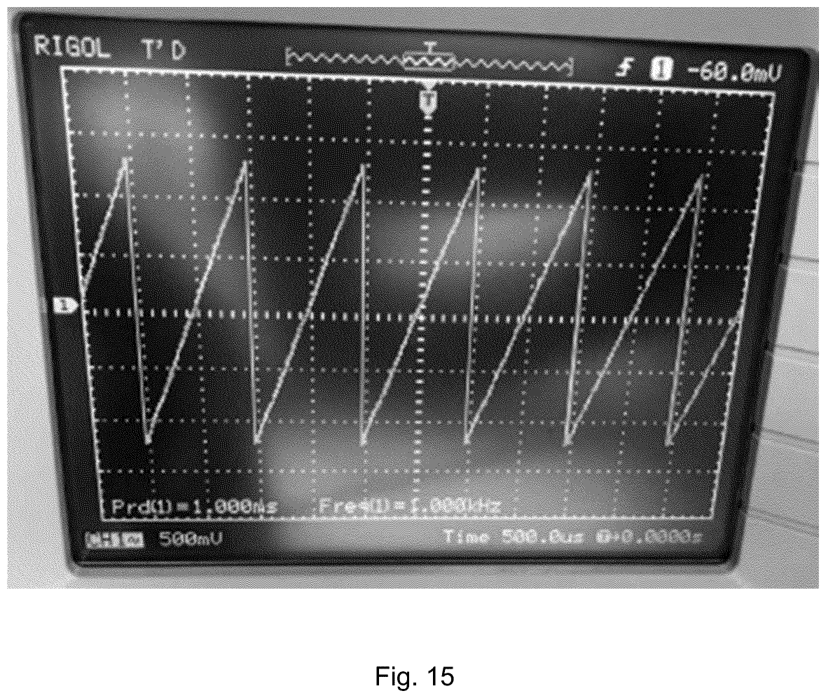

FIG. 14 illustrates a simulation output from the DAC RTL implementation. FIG. 15 illustrates the oscilloscope output from the DAC RTL implementation.

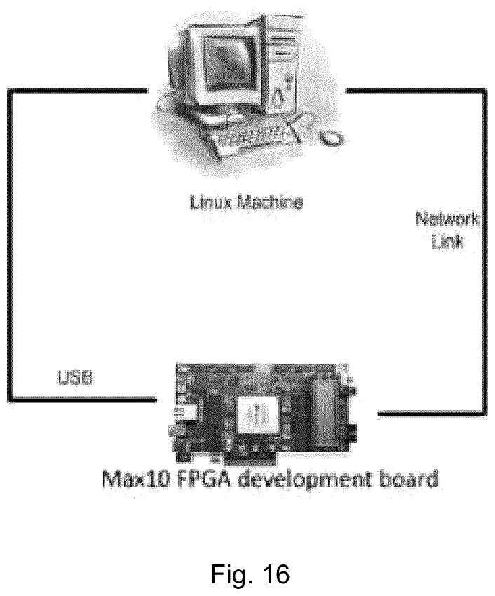

The NIOS II Development environment, which is illustrated in FIG. 16, includes 2 systems (1) the host system that is used for linking, compiling, remote debugging and (2) the target system that uses a Max10 FPGA development board. The board acts as a target for application development.

A computer with an operating system such as Linux acts as the development host. It has the required software for NIOS processor development. The Linux tool chain for the NIOS processors were tested such as using CentOS.

Altera Quartus 17.1 Prime standard version and the NIOS II EDS software for FPGA configuration flash programming and host-target communication using the Altera USB Blaster.

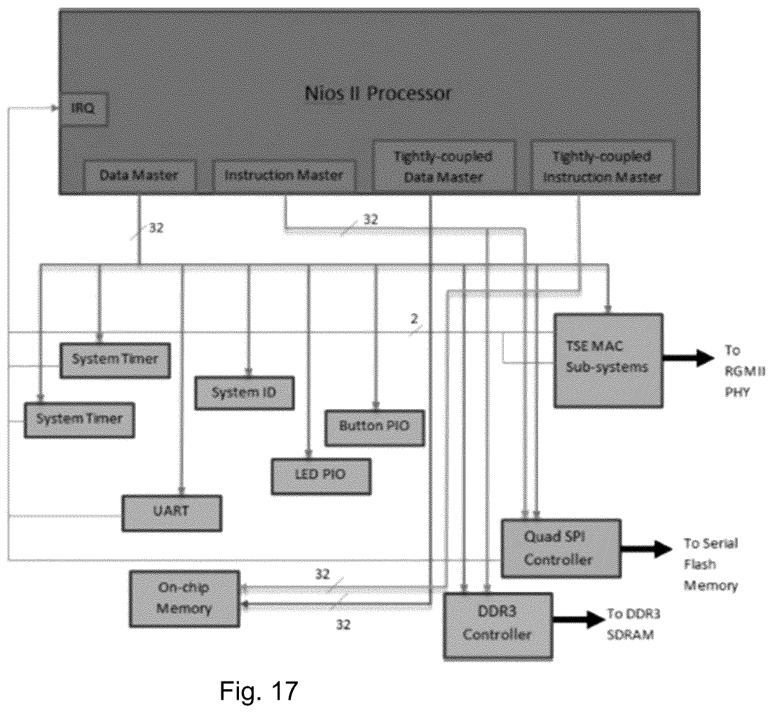

Using the Platform designer, a minimum processor system has been implemented which also includes some of the below features Nios II/f core, MMU, DDR3 SDRAM, Modular ADC, RGMII Ethernet16, JTAG UART and external flash. A schematic diagram of the components in the NIOS development environment is set forth in FIG. 17.

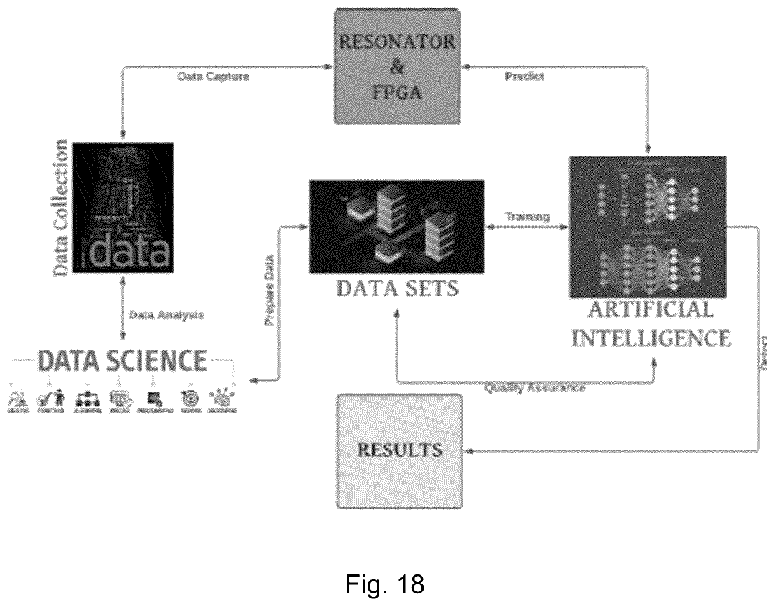

FIG. 18 illustrates the process flow and software development cycle that includes artificial intelligence having (1) data collection, (2) data science, (3) data sets and (4) artificial intelligence

Data collection includes digitalizing, storing, organizing, and maintaining data received from resonator is a part of the development. Files are collected systematically in the unique category formats as needed and stored on servers. Databases and HDFS are used to structure and organize received raw data from the resonator before being processed or analyzed.

Data science is the field of applied mathematics and computer science used to understand and interpret the data produced by algorithms and machines. Analogies and tools are created to exploit collected data and understand the meaning of the data. Finding patterns and developing statistical models based on very small amount data to develop software and technique to use in large-scale data analysis.

Then data is standardized to convert into a format that is easier to work with and later transformed into computer code and executed for processing. The level of understanding and identifying patterns on the data from the resonator during this process is used in training artificial intelligence modules.

Creating data sets is the process of grouping data after analyzing, transforming, and formatting raw data from the resonator to train the artificial intelligence module as part of supervised learning. The same data sets are also used to measure artificial intelligence performance and for human understanding of data before the data is handed over to the machine.

Machine learning creates computer systems that use data to learn and identify targets instead of a developer who specifies instructions line by line in the form on programming code. The software independently updates its code after the first trigger and optimize it for better result.

Deep learning is a machine learning with multi-layered artificial neural networks that recognize patterns in data with increasing accuracy. A combination of multiple types of deep leaning algorithms are used here, like convolution neural network, Bayesian neural network, long short-term memory neural network, etc.

Artificial neural networks are inspired by a rudimentary picture of the human brain: an algorithm creates different layers of connected neurons or nodes that exchange information with each other. The architect consists of an input layer, a middle layer, a hidden layer, and an output layer. The input signal is modified by the initially randomly generated valued of the middle neurons and passed on to the output layers.

The output is compared with the input to determine if the prediction correct. Based on the result, the values of the middle neurons are modified, and the process is repeated with a new input. With many repetitions, the predictions become more and more precise. Neural networks are algorithms that optimize themselves. Deep learning is machine learning with neural networks with more than one hidden layer.

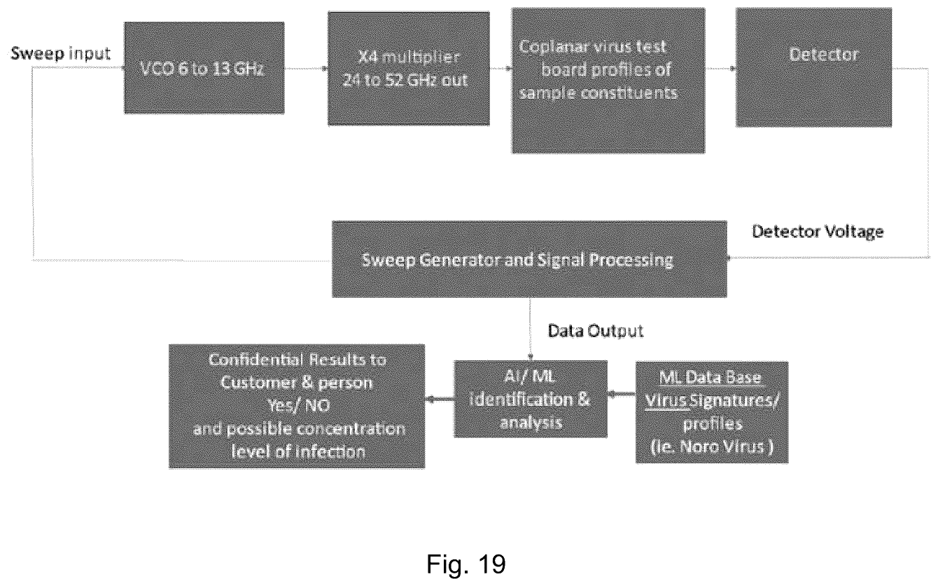

FIG. 19 includes a block diagram for using the invention in conjunction with a noro virus pathogen detection system. The VCO scans at frequencies of between about 6 GHz and 13 GHz. The 4 times multiplier increases the output to in the range of between about 24 GHz and about 52 GHz.

Sample of constituent viruses are put on the coplanar virus test board which are then put through the detector utilizing a sweep generator and signal processing. The data output is then subject to artificial intelligence and machine learning for identification and analysis using a virus signature database.

The results are then used to generate a report that is conveyed to the customer or person who requested the test. In addition to indicating whether the sample tests positive for a particular virus, the results may also indicate the likely concentration of the pathogen in the sample to provide an indication on the level of the infection.

Based upon the preceding description, the invention is directed to a simplified pathogen detection system that rapidly detects and identifies pathogens in a relatively small amount of liquid such as 100 microliters of liquid biological sample in a sample tube.

The pathogen detection system may utilize a 5-ohm microstrip on a coplanar board by which when a sample is placed on the 50 Ohm line of the coplanar board, the sample provides a unique vibration via radio frequency transmitted signal that passes under the sample. The signal resonated biological constituent profiles are machine learned by which the artificial intelligence section uses the signatures to rapidly identify pathogen profiles in a biological liquid sample.

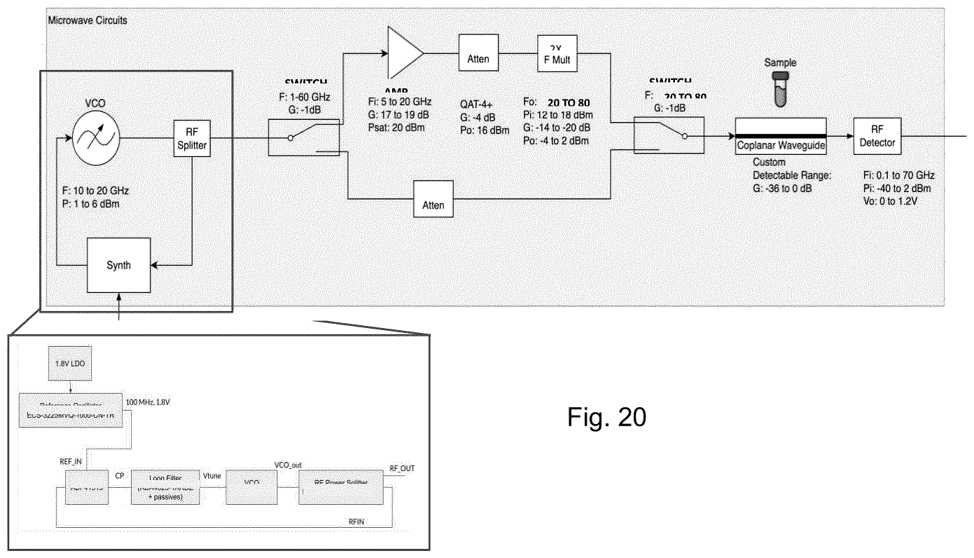

A high sensitive circuit configuration of the pathogen detection system that can detect pathogens over 1 to 80 GHz range is Shown in FIG. 20. This drawing includes an external control electronic that allows remote computer operations.

This simplified circuit layout uses a microprocessor instead of an FPGA and integrates the VCO into a synthesizer to minimize noise and maximize frequency stability when tested a sample. Wide band amplifiers, attenuators, detector components are integrated with a wide range switches are utilized to extend the frequency range from 1 to over 80 GHz for the detector.

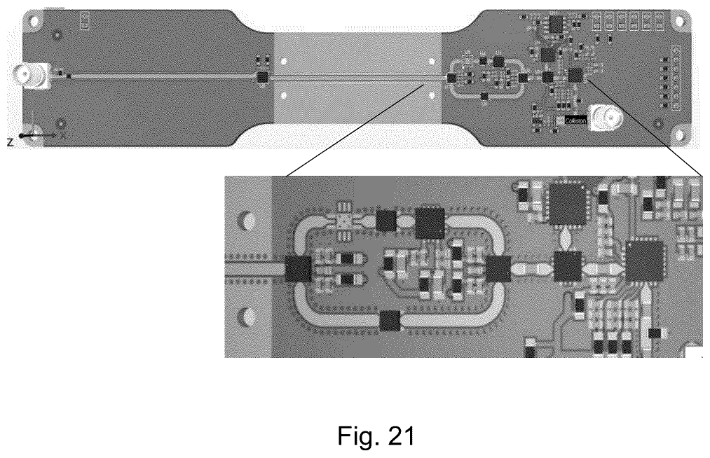

FIG. 21 displays an actual circuit board of this version of the system. The preceding circuit configuration and circuit board layout allows the combined capabilities of detection pathogen at larger diameter typically at the lower frequencies [0 to 20 GHz such as SARs-CoV2 (Covid), Influenza, etc.] and detection of pathogens with smaller diameter such as Noro Virus at higher frequencies (20 to 80 GHz such as Noro and other small diameter pathogens).

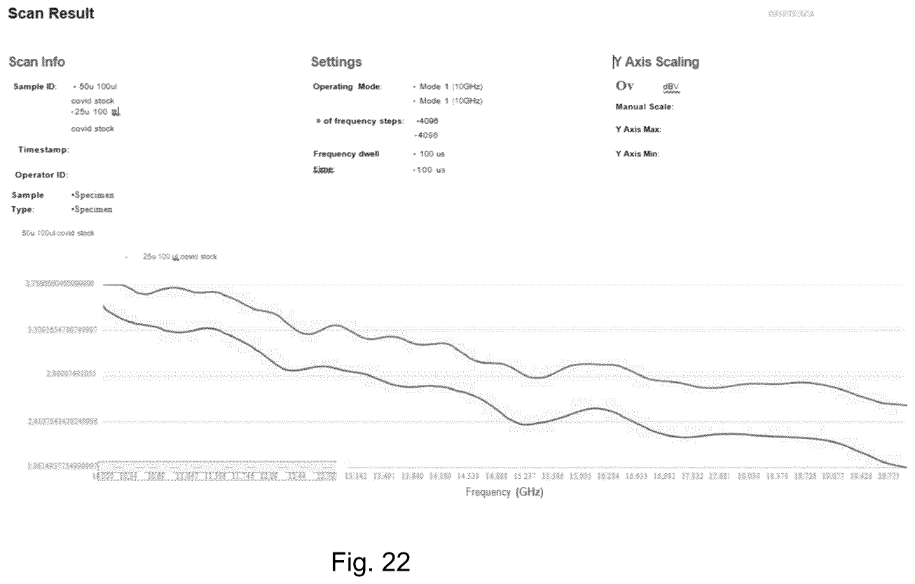

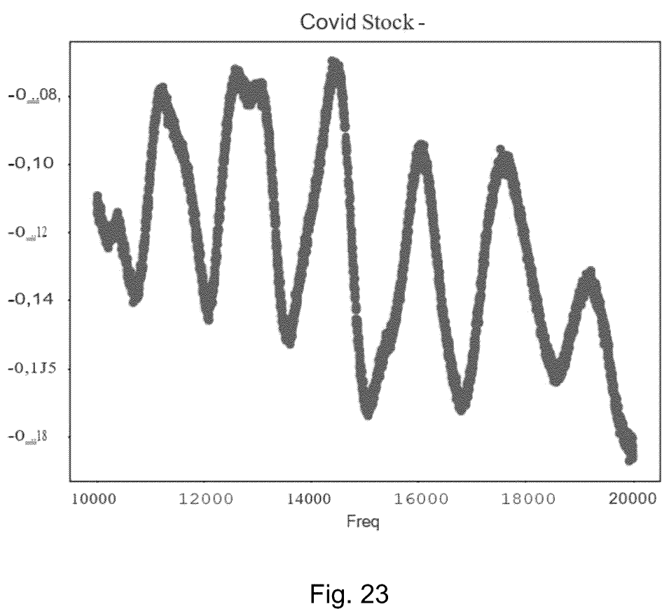

FIG. 22 with the interface control option and FIG. 23 data show sample test results of the above simplified version pathogen detector result of testing a sample of SARs CoV 2 (Covid) with low and high amplitude adjustment, respectively.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A pathogen detection method comprising:
collecting a sample that potentially contains a pathogen;
producing a triangle wave form output;
transmitting a signal associated with the triangle wave form from a voltage-controlled oscillator over a plurality of frequencies;
transmitting the signal through the sample to cause the pathogen in the sample to vibrate at a frequency;
detecting the vibrations from the sample;
calculating a resonance profile of a pathogen in the sample based upon the vibrations;
providing a database that includes a resonance profile signature of at least one pathogens; and
comparing the calculated resonance profile to the resonance profile signature database to determine if the sample includes the pathogen.

2. The pathogen detection method of claim 1, wherein the calculated resonance profiles are modeled, extrapolated and captured using artificial intelligence.

3. The pathogen detection method of claim 1, wherein the resonance profile is calculated using a multivariate regression analysis equation.

4. The pathogen detection method of claim 3, wherein the resonance profile of the pathogen is calculated using the eigenvalue equation 4(J₂(ζ)/(J₁(ζ)ζ−η²+2(J₂(η)/J₁(η)) η=0.
Where: ζ=2πvR/V_{L}
η=2πvR/V_{T}
J₁ and J₂ are spherical Bessel functions of the first and second kinds, respectively
R is the radius of the virus
V_{L} and V_{T} are the sound velocities of the longitudinal and transverse waves respectively
V_{L} may be around 1,700 meters per second
Ratio between V_{L} and V_{T} may be around 2

5. The pathogen detection method of claim 1, and further comprising calculating a concentration of the pathogen in the sample.

6. The pathogen detection method of claim 1, wherein the triangle wave form output is produced using a field programmable gate array and wherein the method further comprises amplifying the signal.

7. The pathogen detection method of claim 1, wherein the signal is transmitted using a 50-ohm microstrip line.

8. The pathogen detection method of claim 1, wherein a concentration of the pathogen in the sample is greater than about 300 virion per milliliter.

9. The pathogen detection method of claim 1, wherein the sample is at least partially a liquid.

10. A pathogen detection method comprising:
collecting a liquid sample that potentially contains a pathogen;
producing a triangle wave form output using a field programmable gate array;
transmitting a signal associated with the triangle wave form from a voltage-controlled oscillator over a plurality of frequencies using a 50-ohm microstrip line;
transmitting the signal through the sample to cause the pathogen in the sample to vibrate at a frequency;
detecting the vibrations from the sample;
calculating a resonance profile of a pathogen in the sample based upon the vibrations;
providing a database that includes a resonance profile signature of at least one pathogens; and
comparing the calculated resonance profile to the resonance profile signature database to determine if the sample includes the pathogen.

11. The pathogen detection method of claim 10, wherein the calculated resonance profiles are modeled, extrapolated and captured using artificial intelligence.

12. The pathogen detection method of claim 10, wherein the resonance profile is calculated using a multivariate regression analysis equation.

13. The pathogen detection method of claim 12, wherein the resonance profile of the pathogen is calculated using the eigenvalue equation 4(J₂(ζ)/(J₁(ζ)ζ−η²+2(J₂(η)/J₁(η))η=0.
Where: ζ=2πvR/V_{L}
η=2πvR/V_{T}
J₁ and J₂ are spherical Bessel functions of the first and second kinds, respectively
R is the radius of the virus
V_{L} and V_{T} are the sound velocities of the longitudinal and transverse waves respectively
V_{L} may be around 1,700 meters per second
Ratio between V_{L} and V_{T} may be around 2

14. The pathogen detection method of claim 10, and further comprising calculating a concentration of the pathogen in the sample.

15. The pathogen detection method of claim 10, and further comprising amplifying the signal and wherein a concentration of the pathogen in the sample is greater than about 300 virion per milliliter.

16. A pathogen detection method comprising:
collecting a sample that potentially contains a pathogen;
producing a triangle wave form output using a field programmable gate array;
transmitting a signal associated with the triangle wave form from a voltage-controlled oscillator over a plurality of frequencies;
transmitting the signal through the sample to cause the pathogen in the sample to vibrate at a frequency;
detecting the vibrations from the sample;
calculating a resonance profile of a pathogen in the sample based upon the vibrations using the eigenvalue equation 4(J₂(ζ)/(J₁(ζ)ζ−η²+2(J₂(η)/J₁(η))η=0.
Where: ζ=2πvR/V_{L}
η=2πvR/V_{T}
J₁ and J₂ are spherical Bessel functions of the first and second kinds, respectively
R is the radius of the virus
V_{L} and V_{T} are the sound velocities of the longitudinal and transverse waves respectively
V_{L} may be around 1,700 meters per second
Ratio between V_{L} and V_{T} may be around 2
providing a database that includes a resonance profile signature of at least one pathogens; and
comparing the calculated resonance profile to the resonance profile signature database to determine if the sample includes the pathogen.

17. The pathogen detection method of claim 16, wherein the calculated resonance profiles are modeled, extrapolated and captured using artificial intelligence.

18. The pathogen detection method of claim 16, and further comprising calculating a concentration of the pathogen in the sample.

19. The pathogen detection method of claim 16, and further comprising amplifying the signal and wherein the signal is transmitted using a 50-ohm microstrip line.

20. The pathogen detection method of claim 16, wherein a concentration of the pathogen in the sample is greater than about 300 virion per milliliter.
